(19) United States
(12) Patent Application Publication
(10) Pub. No.: US 2013/0091861 A1
(43) Pub. Date: Apr. 18, 2013

(54) TURBINE

(71) Applicant: Cornelis Groot, Huisduinen (NL)

(72) Inventor: Cornelis Groot, Huisduinen (NL)

(73) Assignee: WEST 6 B.V., Den Helder (NL)

(21) Appl. No.: 13/695,530

(22) PCT Filed: Apr. 28, 2011
(86) PCT No.: PCT/NL2011/050288

§ 371 Date: Dec. 27, 2012

(30) Foreign Application Priority Data
Apr. 29, 2010 (NL) 2004627

(51) Int. Cl. F01D 5/02; F02C 7/00

(52) U.S. Cl. CPC F01D 5/02; F02C 7/00
USPC 60/784; 416/119

(57) ABSTRACT

A turbine includes a rotor having at least two rotor members for rotating in a plane, the rotor members being substantially diametrically arranged and attached to an axis situated substantially transversely to the plane, and drive unit coupled to the axis, wherein the rotor members include a fluid contact member, that is hingingly connected to an arm which is attached to the axis, characterized in that the fluid contact members are adapted to hinge between a fluid-active position in which the members project transversely to the plane and a fluid-transparent position in which the members extend mainly parallel to the plane.

### FIELD OF THE INVENTION

The invention relates to a turbine, comprising a rotor having at least two rotor members for rotating in a plane, the rotor members being substantially diametrically arranged and attached to an axis situated substantially transversely to the plane, and drive unit coupled to the axis, wherein the rotor members comprise a fluid contact member that is hingingly connected to an arm which is attached to the axis.

### BACKGROUND OF THE INVENTION

Such a turbine, in the particular case a vertical axis wind turbine, is known from US2010/0054936, showing a vertical axis wind turbine in which the wind contact members comprise airfoils that extend transversely to the plane of rotation and that can hinge around a substantially vertical axis to be aligned with the wind direction striking the surface. The known wind turbine has a relatively large footprint and projects in a vertical plane with consequent negative influence on the environment. Another disadvantage of the known wind turbine is that upon rotation, the airfoils traveling against the wind direction are subject to a relatively large air resistance. Furthermore, the known hinging construction of the airfoils is relatively complex and subject to intensive maintenance.

It is therefore an object of the present invention to provide a fluid turbine with a rotor rotating in a substantially non-vertical plane having a relatively small foot print and being of a compact construction in a vertical direction. It is another object of the present invention to provide a fluid turbine which adjusts its fluid active surface to the fluid load and/or to the load on the axis in a simple and automatic manner. It is a further object of the present invention to provide a fluid turbine which is relatively cheap and subject to relatively little maintenance.

### SUMMARY OF THE INVENTION

Hereto a fluid turbine in accordance with the present invention is characterized in that the fluid contact members are adapted to hinge between a fluid-active position in which the members projects transversely to the plane and a fluid-transparent position in which the members extends mainly parallel to the plane.

By situating the fluid contact members in such a manner that they can hinge into and out of the plane of rotation, the fluid impinging upon the members will push the contact members downwardly when the rotor ravels in the fluid direction, while the members are lifted to extend substantially parallel to the plane of rotation when the fluid contact members travel against the fluid direction. In this way, the fluid contact members are automatically placed in the proper position, depending on the fluid speed and on the load on the axis. As used herein, the term “fluid-active position” is intended to mean a position in which the fluid contact member has a relatively large projected surface area perpendicular to the plane, whereas with “fluid-transparent position” it is intended to mean a position in which the fluid contact member has a relatively small projected surface area perpendicular to the plane and a relatively large projected surface area situated in the plane of rotation.

The turbine according to the present invention may be used in air to act as a wind turbine, but also under water to interact with currents.

When the fluid speed is low, and/or the load on the axis is high, the fluid contact members will hinge downward or upward relative to the plane of rotation until the fluid-active area (perpendicular to the fluid direction) becomes sufficiently large for the fluid turbine to rotate. Upon rotation back against the fluid direction, the fluid contact member may be lifted upwards or pushed downward by the fluid to such an extent that it is situated substantially in the plane of rotation, in which position the fluid resistance is lowest.

The fluid turbine according to the invention has a relatively small footprint such that it may be used in built up areas, such as on roof tops in cities, or on small plots of land.

It is also of compact vertical dimensions such that its visual impact on the environment is slighter.

Because of the automatic adjustment of the fluid-actives members of the rotors, the rotor position of the fluid-turbine will be optimally adjusted to prevailing fluid and load conditions without requiring complex mechanical parts or expensive control electronics, such that an effective, continuous, fail-safe, reliable and relatively cheap generation of wind or water energy can be provided.

Although the fluid contact members may be comprised of rigid parts which have a hinging interconnection, a fluid turbine in accordance with a preferred embodiment is characterized in that the fluid contact members comprise a flexible material, the contact members being with one side connected to the frame and having a free end, the free end in the fluid-active position being bent away from the plane by a fluid force having a component situated parallel to the plane, in a first angular position of the axis, and being lifted away from the fluid active position to the fluid-transparent position at a second angular position of the axis. In this embodiment, the fluid-contact members may be comprised of flexible sheet material that is able to “flap” up and down depending on the rotational position, much like a wing of a bird, to have an optimal fluid resistance suitable for driving the axis of the fluid turbine or for being rotated back against the fluid into its starting position.

The flexible fluid-contact members may be made of a metal, a plastic, a composite material or laminates thereof. The fluid-contact member may be curved or profiled to have wing-like cross-section or may be flat.

The turbine comprises at least two arms, and can have three or more arms in order to be self-starting.

In one embodiment, the frame comprises at least 4 arms, the rotor members comprising a flexible surface having a first side situated substantially parallel to the arm and attached to said arm, two long sides extending transversely to the arm and a free side extending substantially parallel to the arm at a distance thereof. Each arm may extend from a central hub going through the axis, outwardly to a circumferential position.

The fluid-contact member may extend along the whole arm or along an end section of each arm, perpendicular to the arm, the free end of the member being able to move perpendicular to the plane (upward or downward).

The drive unit of the fluid-turbine may comprise a power generating unit for generating electrical power, such as for instance a known electrical generator. Alternatively, the fluid turbine may be constructed on the deck of a vessel or on a vehicle on wheels for direct propulsion purposes, such that the drive unit comprises a vessel hull or an electric engine on a chassis on wheels.

The plane of rotation of the rotors may be a stationary horizontal plane, but it can be advantageous to provide an adjustment member, for instance a hydraulic cylinder, for adjusting the angle of the axis relative to a vertical direction.

In a further embodiment, the fluid turbine may be constructed as interconnectable modules, an assembly of fluid turbines being formed by each fluid turbine comprising a cylindrical wall, having a fluid transparent area arranged around the arms and connected to the axis, the cylindrical walls and the axes of each fluid turbine being releasably connected. By stacking a number of fluid turbines the power of an assembly may be tailored to a particular application or to prevailing fluid conditions.

### BRIEF DESCRIPTION OF THE DRAWINGS

An embodiment of a fluid-turbine in accordance with the present invention will be explained in detail with reference to the accompanying drawings. In the drawings:

FIG. 1 is a perspective view of a wind turbine according to the invention,

FIGS. 2a and 2b are side views of a flexible wind-control member travelling in the wind direction and against the wind direction, respectively.

FIG. 3 shows a top view of the wind turbine of FIG. 1, and

FIG. 4 shows an embodiment of a modular arrangement of a wind turbine according to the invention.

### DETAILED DESCRIPTION OF THE INVENTION

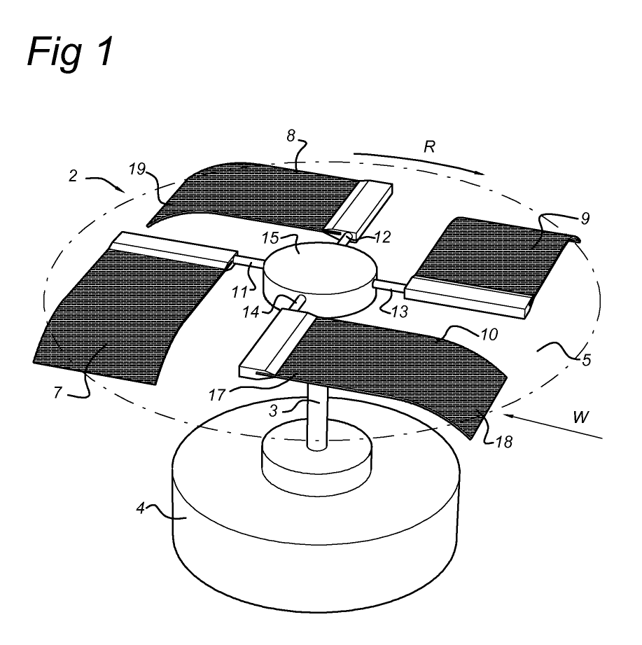

FIG. 1 shows a perspective view of an exemplary embodiment of a wind turbine 1 according to the invention, having a rotor 2 rotating in a plane of rotation 5, and attached to an axis 3. The axis 3 is connected to a drive unit 4, which may comprise an electric generator, an electric engine, a chassis on wheels, a vessel and the like. The rotor 2 is provided with four wind-contact members, or blades 7,8,9, 10, each attached via a respective arm 11,12,13,14 to a central hub 15.

Each blade 7-10 comprises a sheet of flexible material, that is with a fixed end 17 connected to a respective arm 11-14 and which has a free end 18 which may be moved transversely to the rotational plane 5. In FIG. 1, the arms 11-14 rotate in the direction of arrow R, at a wind component in the rotational plane 5 in the direction of the arrow W. The free end 18 of blade 10 is moved downward by the force of the wind out of the rotational plane 5 while the blade 17 travels in the wind direction W. The free end 19 of the blade 8 which travels against the wind direction W, is lifted upward by the wind to lie substantially in the rotational plane 5 in which position the blade 8 causes minimal air resistance.

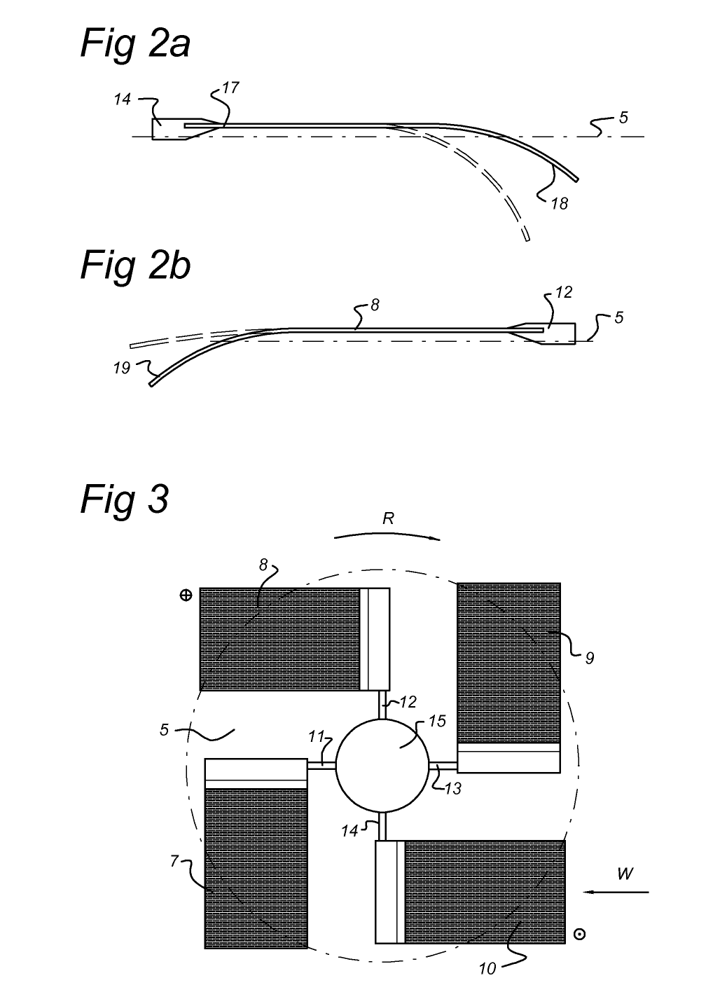

In FIG. 2a, a side view of the blade 17 is shown, the position indicated with dashed lines indicating the blade bending further out of the rotational plane 5 and in this way adjusting to higher wind forces and/or higher loads on the axis 3. In FIG. 2b, the blade 8 is shown to extend in a “fluid-transparent” position in which the air resistance is minimal and the blade extends substantially parallel to the rotational plane 5.

FIG. 3 shows a top view of the wind turbine of FIG. 1, in which the blade 8 is substantially parallel to the rotational plane 5 or is lifted somewhat out of said plane, and the blade 10 is moved downward into the plane of the drawing.

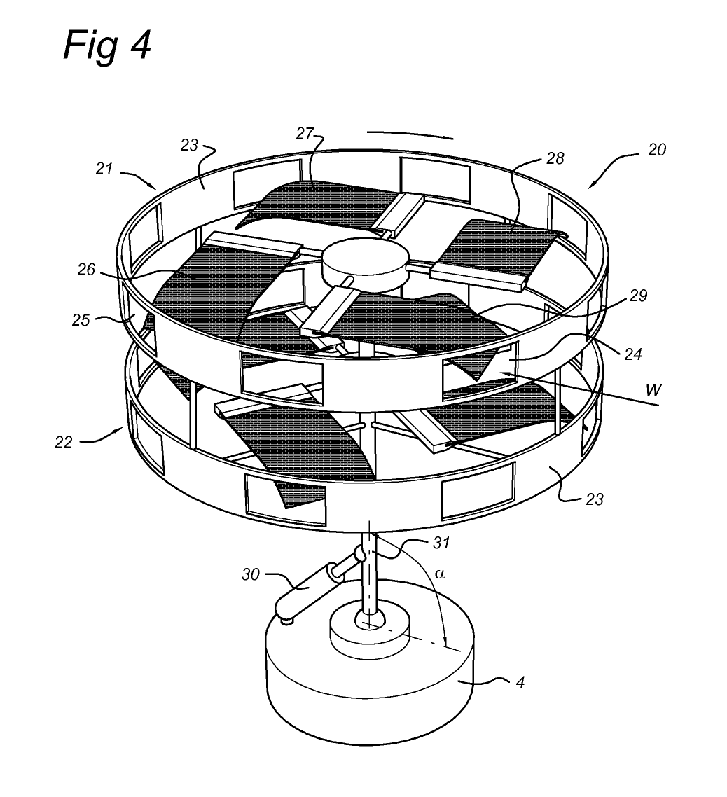

FIG. 4 shows a modular assembly made of two interconnected modules 21, 22 each comprising an annular frame 23 having a number of openings 24, 25 in its wall. The opening 24,25 may comprise the larger part of the surface of the annular wall such that a minimum air resistance is created by the annular frame 23.

The flexible blades 26,27,28,29 rotate within the frames 23. The axes of the modules 21,22 are interconnected and connect to a common drive unit 4. An adjustment member 30, such as a hydraulic cylinder, may be used to vary the angle of the axis 31 relative to the vertical direction.

Even though the fluid turbine in accordance with the present invention has been described with reference to a wind turbine, the invention may also be employed under water for energy generation and may be used as a direct or indirect drive member for the propulsion of vehicles or vessels.

1. Turbine (1) comprising a rotor (2) having at least two rotor members (7,11;8,12;9,13;10,14) for rotating in a plane (5), the rotor members being substantially diametrically arranged and attached to an axis (3) situated substantially transversely to the plane (5), and drive unit (4) coupled to the axis, wherein the rotor members comprise a fluid contact member (7,8,9,10) that is hingingly connected to an arm (11,12,13,14) which is attached to the axis (3), characterized in that the fluid contact members (7,8,9,10,) are adapted to hinge between a fluid-active position in which the members project transversely to the plane and a fluid-transparent position in which the members extend mainly parallel to the plane.

2. Turbine according to claim 1, wherein the fluid contact members (7,8,9,10) comprise a flexible material, the contact members being with one side connected to the arms and having a free end (18,19), the free end in the fluid-active position being bent away from the plane (5) by a fluid force having a component situated parallel to the plane, in a first angular position of the axis (3), and being lifted away from the fluid active position to the fluid-transparent position at a second angular position of the axis (3).

3. Turbine according to claim 1, comprising at least 4 arms (11,12,13,14), the rotor members comprising an flexible surface having a first side situated substantially parallel to the arm and attached to said arm, two long sides extending transversely to the arm and a free side extending substantially parallel to the arm at a distance thereof.

4. Turbine according to claim 1, the drive unit (4) comprising a power generating unit for generating electrical power.

5. Turbine according to claim 1, comprising an adjustment member (30) for adjusting an angle of the axis (31) relative to a vertical direction.

6. Turbine according to claim 1, the drive unit comprising an electric engine of a vehicle.

7. Turbine according to claim 1, the drive unit comprising a vessel.

8. Assembly comprising at least two turbines according to claim 1, each fluid turbine comprising a cylindrical wall (23) having a fluid-transparent area (24,25), arranged around the arms and connected to the axis, the cylindrical walls and the axes of each turbine being releasably interconnected.

9. Turbine according to claim 2, comprising at least 4 arms (11,12,13,14), the rotor members comprising an flexible surface having a first side situated substantially parallel to the arm and attached to said arm, two long sides extending transversely to the arm and a free side extending substantially parallel to the arm at a distance thereof.

10. Turbine according to claim 2, the drive unit (4) comprising a power generating unit for generating electrical power.

11. Turbine according to claim 3, the drive unit (4) comprising a power generating unit for generating electrical power.

12. Turbine according to claim 9, the drive unit (4) comprising a power generating unit for generating electrical power.

13. Turbine according to claim 2 comprising an adjustment member (30) for adjusting an angle of the axis (31) relative to a vertical direction.

14. Turbine according to claim 2, the drive unit comprising an electric engine of a vehicle.

15. Turbine according to claim 2, the drive unit comprising a vessel.
